(19) United States
(12) Patent Application Publication
(10) Pub. No.: US 2014/0346216 A1
(43) Pub. Date: Nov. 27, 2014

(54) PROCESS FOR JOINING BY DIFFUSION WELDING A PART MADE OF STEEL HAVING A HIGH CARBON CONTENT WITH A PART MADE OF STEEL OR NICKEL ALLOY HAVING A LOW CARBON CONTENT: CORRESPONDING ASSEMBLY

(71) Applicant: COMMISSARIAT À L'ÉNERGIE ATOMIQUE ET AUX ÉNERGIES ALTERNATIVES, Paris (FR)

(72) Inventors: Emmanuel Rigal, Sassenage (FR); Isabelle Chu, Fontanil Cornillon (FR)

(73) Assignee: COMMISSARIAT À L'ÉNERGIE ATOMIQUE ET AUX ÉNERGIES ALTERNATIVES, Paris (FR)

(21) Appl. No.: 14/366,800

(22) PCT Filed: Dec. 14, 2012
(86) PCT No.: PCT/EP2012/075559

§ 371 Date: Jun. 19, 2014

(30) Foreign Application Priority Data
Dec. 23, 2011 (FR) 1162395

(51) Int. Cl. B23K 20/02; B23K 35/30

(52) U.S. Cl. CPC B23K 20/02; B23K 35/3046; B23K 35/3053; B23K 35/3033
USPC 228/194

(57) ABSTRACT

Process for joining by diffusion welding a part made of steel having a high carbon content and low carbide-forming elements content with a part made of steel or of nickel alloy having a low carbon content and a high carbide-forming elements content, each of the parts comprising a surface to be joined in which process an intermediate material is placed between the surfaces to be joined, then diffusion welding is carried out to join the two parts, and the assembly obtained is cooled, characterised in that the intermediate material is an alloy, with a matrix made of nickel and optionally of iron and/or cobalt, having an austenitic micro-structure at the welding temperature, and comprising 2 to 25% by mass of molybdenum. Also disclosed is an assembly obtained by this process.

### TECHNICAL FIELD

The present invention relates to a process for joining by diffusion welding a part made of steel having a high carbon content with a part made of steel or nickel alloy having a low carbon content.

More precisely, the invention deals with a process for joining by diffusion welding a part made of steel having a high carbon content and low carbide-forming elements content with a part made of steel or nickel alloy having a low carbon content and a high carbide-forming elements content, wherein an intermediate material is placed between the parts.

The invention also relates to the assembly thus obtained.

The technical field of the invention may be defined in general as being diffusion welding, and in particular diffusion welding of two parts made of different metal alloys between which carbon can diffuse.

### THE STATE OF THE PRIOR ART

It is known that during diffusion welding without an intermediate material between, on the one hand, a steel having a high carbon content and a low total carbide-forming elements content and on the other hand, a steel or nickel alloy having a high carbide-forming elements content and a low carbon content, unsatisfactory joints are obtained.

In effect, diffusion of carbon from the first material to the second material causes carburisation which makes the second material brittle and weakens the first.

FIG. 1 shows the micro-structure of a diffusion welded assembly between a low-alloy steel 16MND5 (Fe-0.17% C-1.31% Mn-0.18% Cr-0.74% Ni-0.5% Mo) (on the right in FIG. 1) and an austenitic 316 LN stainless steel (Fe-0.022% C-17.5% Cr-12.2% Ni-2.4% Mo-0.07% N) (on the left in FIG. 1) (it should be specified that herein all compositions are giving in % by mass) [1].

The interface between the low-alloy steel and the martensitic stainless steel is indicated by the white arrows in FIG. 1.

The decarburisation of the low-alloy steel is manifested as the appearance of white ferrite grains. The carburisation of the austenitic stainless steel is manifested by the appearance of carbides indicated by the black arrows in FIG. 1.

FIG. 2 shows the variation of the carbon concentration across this assembly. In this figure the carburisation/decarburisation phenomena are clearly shown.

The same type of micro-structure is obtained by Enjo in the case of diffusion welding between a carbon steel S45C (Fe-0.47% C) and an austenitic stainless steel SUS304 (Fe-0.05% C-18.5% Cr-8.1% Ni) [2] as well as by Kurt in the case of diffusion welded assemblies between a low-alloy steel AISI 4140 (Fe-0.42% C-0.72% Mn-0.87% Cr-0.19% Mo) and either a duplex stainless steel (Fe-0.024% C-24.5% Cr-4.23% Ni-0.83% Mo), or an austenitic steel 304 (Fe-0.052% C-19.2% Cr-8.5% Ni) [3].

In order to assess the brittleness of diffusion welded assembly interfaces, use is made of notch impact testing carried out at ambient temperature using Charpy test pieces in which the V- or U-shaped notch is located facing the interface.

In effect this mechanical test is much more sensitive to the brittleness of the interface than the conventional tensile test. The impact strength value of the assembly in document [1] is about 70J as against 310J for the austenitic stainless steel and 214J for the low-alloy steel.

The assembly therefore is clearly of lower strength than its constituent materials, as a result of carburisation/decarburisation effects. In the case, which is very similar to that of document [1], of a diffusion welded assembly between a low alloy steel A508 (Fe-0.19% C-1.52% Mn-0.18% Cr-0.55% Ni-0.49% Mo) and an austenitic 316 L stainless steel (Fe-0.03% C-18.0% Cr-12.0% Ni-2.52% Mo), Besson [4] obtained a brittle fracture which is localised at the interface, using small Charpy V test pieces, although on this occasion the notch was not machined opposite the interface but 1 mm from it, which nevertheless is less favourable to an opening up of the interface.

In the case of materials obtained by compacting of a blend of powders of 10CrMo9-10 steel (typically Fe-0.10% C-2.25% Cr-1% Mo) and AISI316 steel (typically Fe-<0.08% C-17.0% Cr-12.0% Ni-2.5% Mo) in a proportion which varies from 3/7 to 8/2, Prader obtains impact strength KCV values of from 70 to 110J, or 55% to 70% of those for the base steels alone [5]. Values closer to 100% are only achieved for less diluted blends. It can be seen that the notch impact strength of the material depends on the density of the 10CrMn9-10/AISI316 interfaces since these are brittle, as in the case of diffusion welded joints.

Furthermore, the use of an intermediate material to facilitate welding diffusion between two materials is known [6]. One possible solution for preventing the diffusion of carbon is therefore to insert an intermediate material which acts as a barrier between the two materials to be welded.

Obviously, this intermediate material must not itself form carbides. Buchkremer [7] reports that the assembly between a P92 steel (typically Fe-0.1% C-9% Cr-2% W) and a 1.4910 steel (typically Fe-0.02% C-17% Cr-13% Ni-3% Mo—N) exhibits less favourable mechanical properties when an intermediate material made of Ni-16% Cr-15% Mo (Hastelloy S) is used, than when the assembly is made without an intermediate material. In effect in the first case, the intermediate material Ni-16% Cr-15% Mo is highly carburised during assembly.

Neither must the intermediate material form brittle compounds with the materials to be assembled, such as, for example, intermetallic compounds, nor again must it be brittle itself. Such an intermediate material may therefore be a substantially pure metal such as copper, nickel or silver, the use of which is known in diffusion welding [6].

In general the use of an intermediate material is effective in controlling diffusion effects in the vicinity of interfaces, but it does not always improve the mechanical properties of assemblies, since the intermediate material is often of lower strength than the two materials to be assembled. In the case of tensile testing, this weakness of the intermediate material may, it appears, be compensated for by choosing an intermediate material which is thin (but nevertheless thick enough to overcome problems associated with diffusion): confinement promotes failure at an apparent stress which is greater than the mechanical strength of the intermediate material, as Klassen [8] shows, even failure away from the interface.

In the case of an assembly between a manganese steel Fe-12.5% Mn-1.23% C and a low alloy steel Fe-0.45% C-1.3% Cr-0.3% Mo-4.0% Ni, Atkinson seeks to limit the thickness of the pure nickel used as an intermediate material in order not to have too great an adverse effect on the strength of the assembly [9]. In the case of the notch impact strength test, the notch is located halfway through the thickness of the intermediate material. The confinement achieved by a thin intermediate layer does not improve the impact strength.

From what has gone before it emerges that the problem of assembly by diffusion welding between, on the one hand, a steel having a high carbon content and a low total carbide-forming elements content and, on the other hand, a steel or nickel alloy having a high carbide-forming elements content and a low carbon content has until now not found a completely satisfactory solution.

Therefore there exists a need for an assembly process by diffusion welding of a part made of steel having a high carbon content and a low carbide-forming elements content with a steel or nickel alloy part having a low carbon content and a high carbide-forming elements content, using an intermediate material which produces a high-strength mechanical assembly with high levels of impact strength, and in any case greater than those in the prior art described above.

There also exists a need for such a process which does not cause deterioration either of the interfaces between the intermediate material and the parts, or the parts to be assembled.

The intermediate material must therefore suppress the brittleness of the materials of the parts due to the diffusion of carbon, but also allow a strong assembly to be obtained, even with a thick intermediate material.

It should be specified that by thick intermediate material it is generally meant a material whose thickness is greater than that strictly necessary to prevent carburisation of the steel or nickel alloy of low carbon content and of high carbide-forming elements content, for example a thickness greater than 0.3 mm.

For the assembly to be as strong as possible (the assembly may be as a maximum as strong as the weaker of the two base materials which constitute the two parts to be assembled), it is necessary that:
the interface or interfaces are strong. It is known that this is not so for direct assembly, as a result of carburisation;
that the intermediate material not only exhibits strong interfaces with each of the two base materials of the parts, but that it is itself stronger than the weaker of the two base materials, otherwise this will still be a weak point.

The goal of the present invention is to provide a process for joining by diffusion welding a part made of steel having a high carbon content and low carbide-forming elements content, with a part made of steel or nickel alloy having a low carbon content and a high carbide-forming elements content which, amongst other things, meets all the needs, requirements and criteria stated above.

The goal of the present invention is further to provide a process for joining by diffusion welding a part made of steel having a high carbon content and low carbide-forming elements content, with a part made of steel or of nickel alloy having a low carbon content and a high carbide-forming elements content which does not exhibit the drawbacks, faults, limitations and disadvantages of the processes of the prior art described above, and which solves the problems with the processes of the prior art.

### SUMMARY OF THE INVENTION

This goal, and others still, are achieved, according to the invention by a process for joining by diffusion welding a part made of steel having a high carbon content and a low carbide-forming elements content with a part made of steel or of nickel alloy having a low carbon content and a high carbide-forming elements content, each of the parts comprising a surface to be joined, in which process an intermediate material is placed between the surfaces to be joined, then diffusion welding is carried out to join the two parts, and the assembly obtained is cooled, characterised in that the intermediate material is an alloy, with a matrix made of nickel and optionally of iron and/or cobalt, having an austenitic micro-structure at the diffusion welding temperature, and comprising, apart from unavoidable impurities, the following elements with the following contents, expressed as % by mass relative to the total mass of the alloy:
Nickel (Ni): 5 to 90, preferably 35 to 75;
Cobalt (Co): 0 to 50, preferably 0 to 20;
Iron (Fe): 0 to 93, preferably 23 to 63;
Molybdenum: 2 to 25, preferably 4 to 16;
Carbon: less than 0.1, preferably less than 0.05;
Chromium: less than 10, preferably less than 5, more preferably yet less than 1;
Alloy elements commonly used in austenitic alloys, for each of them: less than 2, preferably less than 1, more preferably less than 0.5.

The terms “unavoidable impurities” or “accidental impurities” have a meaning known to those skilled in the art and are widely used in this field of the technique.

Examples of such unavoidable impurities are sulphur (S), phosphorous (P), copper (Cu), alkali metals and alkaline-earth metals.

The process according to the invention is fundamentally defined by the use of the above specific alloy as an intermediate material.

The use of the specific alloy, as has been defined above, as the intermediate material for joining of two parts, each made of a specific material, namely on the one hand a part made of steel having a high carbon content and a low carbide-forming elements content and on the other hand a part made of steel or of a nickel alloy with a low carbon content and a high carbide-forming elements content, is not described or suggested in the prior art, notably as represented by the documents cited above.

Such a use is totally unexpected, in particular by virtue of the unforeseeable character of the behaviour of a material as an intermediate material between two specific metals or alloys.

The process according to the invention wherein the intermediate material is surprisingly made up of the specific alloy described above meets, amongst others, all of the requirements and criteria stated above, does not exhibit the drawbacks of the processes of the prior art and allows junctions (joints or links) and assemblies to be made which also meet the aforementioned requirements.

The alloy of the intermediate material according to the invention may be defined as an alloy with a base of nickel and optionally of cobalt and/or of iron enriched with molybdenum.

It surprisingly turns out in effect that the presence of molybdenum in the alloy which makes up the intermediate material leads to an improvement in the mechanical properties of the intermediate material relative to the intermediate materials of the prior art, without, nevertheless, the intermediate material being carburised by the diffusion of carbon during the diffusion welding operation (see the examples and in particular example 4).

It is surprising that the inclusion of molybdenum in the intermediate material increases the hardness of the austenitic matrix of the intermediate material, without the latter being carburised by diffusion.

In effect, it is known that molybdenum results in finer grain sizes of austenitic alloys, but also it is also known that molybdenum forms carbides.

One should therefore have expected that by including molybdenum in the alloy which constitutes the intermediate material, that the mechanical properties of the intermediate material would be adversely affected relative to a material which does not contain molybdenum. However, the contrary is observed in the intermediate material according to the invention.

The invention therefore goes against a widespread prejudice in this field of the technique and overturns this prejudice.

Furthermore, the molybdenum is present in the alloy which constitutes the intermediate material used according to the invention at a specific content.

The molybdenum content of the alloy which constitutes the intermediate material must be sufficient for the mechanical properties of the intermediate material to be substantially equal to or superior to those of the weaker of the two materials to be assembled. In effect the hardening effect of the Mo apparently depends on the Mo content.

Consequently it has been determined, according to the invention that the Mo content must be from 2% to 25% by mass, preferably from 4% to 16%.

It turned out that the hardening effect of the molybdenum was optimum in this preferred range.

In effect below 2% of Mo, the hardening effect due to the molybdenum is too weak to be of use, in other words, there would be no case of assembly wherein an intermediate material containing less than 2% of molybdenum could be stronger than the weaker of the two base materials, since then the weaker of the two base materials would have to be really soft.

Beyond 25% Mo, it is well known that Mo causes the precipitation of brittle intermetallic phases and therefore the intermediate material would also become quite brittle, whilst remaining hard.

The intermediate material is an alloy with a matrix of nickel and optionally of iron and/or of cobalt having an austenitic micro-structure, that is, a faced-centred cubic crystalline structure at the assembly temperature, for example at a temperature above 800° C.

Herein, the assembly temperature must be understood to mean the temperature at which the diffusion welding is carried out, and the terms assembly temperature and diffusion welding temperature are used interchangeably.

This alloy therefore contains, in addition to the unavoidable impurities, the following elements which are the constituent elements of the matrix with the following specific contents expressed in % by mass.
Nickel (Ni): 5 to 90, preferably 35 to 75;
Cobalt (Co): 0 to 50, preferably 0 to 20;
Iron (Fe): 0 to 93, preferably 23 to 63.

It will be noted therefore that nickel is always present since this element ensures that the matrix exhibits the desired austenitic micro-structure.

The Ni content is as defined above. It ensures that the alloy of the intermediate material used according to the invention is austenitic at the assembly or diffusion welding temperature which is above 800° C.

On the other hand it is not mandatory for the cobalt and iron to be present.

The alloy of the intermediate material used according to the invention may therefore be a Nickel-Cobalt alloy or a Nickel-Iron alloy or a Nickel-Iron-Cobalt alloy, with these alloys being enriched with molybdenum.

The alloy of the intermediate material according to the invention may simply be a Ni—Mo alloy.

Alloys without cobalt are of interest for cost reasons and for reasons of neutron activation in nuclear applications.

The alloy of the intermediate material in addition exhibits a sufficiently low carbon content for it not to substantially carburise the steel or the nickel alloy which has a high carbide-forming elements content and a low carbon content.

The carbon content of the alloy of the intermediate material is therefore less than 0.10% by mass, preferably less than 0.05% by mass.

Furthermore, the intermediate material alloy exhibits a chromium (Cr) content which is sufficiently low for it not to be carburised by the steel having a high carbon content.

Its chromium content is less than 10% by mass, preferably less than 5%, and yet more preferably less than 1%.

The alloy of the material according to the invention may optionally include one of more alloy element(s) commonly used in austenitic alloys.

These alloy elements, their role and their content are known to the man skilled in the art in this technical field.

These alloy elements mainly play a role during the production of the alloy in trapping certain impurities, and do not substantially affect the properties, notably the mechanical properties, of the final alloy.

The content of this/these alloy element(s) when they are present is, for each of them, less than 2% by mass, preferably less than 1% by mass and yet more preferably less than 0.5%.

Advantageously, the intermediate material alloy comprises one or more among the following alloy elements commonly used in austenitic alloys with the following contents, expressed as % by mass relative to the total mass of the alloy:
Manganese (Mn): less than 2;
Silicon (Si): less than 1;
Calcium (Ca): less than 0.5, preferably less than 0.1;
Aluminium (Al): less than 1, preferably less than 0.5.

Manganese is used to trap sulphur, and silicon and aluminium are used to trap residual oxygen.

Calcium traps oxygen and sulphur.

A preferred intermediate material alloy consists of, in % by mass relative to the total mass of the alloy:
Nickel: 35% to 55%, for example 45.3%;
Cobalt: 0 to 18%, for example 9.97%;
Molybdenum: 4 to 8%, for example 5.19%;
and the remainder being iron and unavoidable impurities.

Generally, the steel having a high carbon content and low carbide-forming elements content may include more than 0.08% by mass of carbon and less than 15% by mass of carbide-forming elements, preferably, among these carbide-forming elements, less than 12% of chromium, and the steel or nickel alloy having a low carbon content and high carbide-forming elements content comprises 0.08% by mass or less of carbon and 15% by mass or more of carbide-forming elements.

Generally the carbide-forming elements may be chosen from the elements of column IVB such as Ti, Zr, and Hf, VB such as V, Nb, and Ta, and VIB such as Cr, Mo, and W, of the periodic table of the elements.

Advantageously the steel having a high carbon content and low carbide-forming elements content may be chosen from carbon steels grades such as engineering steels, or from low-alloy steels grades such as steels for pressure equipment or tool steels.

Advantageously, the steel or nickel having a low carbon content and a high carbide-forming elements content may be chosen from stainless steels such as the 300 series austenitic stainless steels and alloy 800 or from nickel alloys such as Inconel®, Haynes®, or Hastelloy® type alloys.

Advantageously at least one of the parts to be assembled may be in the form of powder.

In other words, either or both of the steels having a high carbon content and low carbide-forming elements content and the steel or nickel alloy having a low carbon content and a high carbide-forming elements content may take the form of a solid or the form of a powder.

The intermediate material may be placed between the surfaces to be assembled in the form of a sheet or a plate, for example with a thickness of from 0.1 to 0.3 mm, or of a powder, preferably a layer of powder, for example with a thickness of from 0.3 to 10 mm, preferably from 1 mm to 5 mm, yet more preferably from 1 to 3 mm, and best from 1 to 2 mm. Or the intermediate material is deposited in the form of a coating, for example with a thickness of 0.1 to 3 mm, on at least one of the surfaces to be assembled.

In this case the intermediate material may be deposited by a process chosen from thermal spray-coating of powders, wire melting, chemical or electrolytic deposition and vacuum deposition.

Diffusion welding may be carried out by hot isostatic pressing (HIP) or by uniaxial pressing.

When one or more of the materials occur in the powder form, compaction of the powder(s) is carried out during the diffusion welding.

Advantageously, the assembly obtained may be further subjected to one or more heat treatment(s).

This (these) heat treatment(s) may be chosen from heating (annealing) treatment, quenching and tempering.

The invention relates in addition to the assembly obtained by the process according to the invention as has been described above.

This assembly intrinsically possesses, in an inherent manner, all the advantages already listed above, associated in particular with the use in the assembly process of a specific intermediate material.

Other characteristics and advantages of the invention will emerge more clearly on reading the following description, which is given for illustrative purposes only and is in no way restrictive, with reference to the appended drawings.

### BRIEF DESCRIPTION OF THE DRAWINGS

FIG. 1 is a micro-photograph taken with an optical microscope which shows the micro-structure of a diffusion welded joint between the low alloy 16MND5 steel (on the right), and an austenitic 316 LN stainless steel) on the left. The interface is indicated by white arrows and carbides are indicated by black arrows. The scale shown in FIG. 1 represents 100 μm.

FIG. 2 is a graph which shows the variation in the carbon concentration across the interface in the assembly of FIG. 1.

The abscissa shows the distance from the interface in μm, and the ordinate shows the hardness H_{V0.1}. The interface is at the abscissa zero.

FIG. 3 is a micro-photograph taken using an optical microscope, which shows the damage to the nickel alloy IN690 in the carburised zone of this alloy after a tensile test carried out on the assembly of a 16MND5 steel (top) and a nickel IN690 alloy (bottom) obtained by diffusion welding using Hot Isostatic Pressing in example 1.

The scale shown in FIG. 3 represents 25 μm.

FIGS. 4A and 4B are micro-photographs taken using an optical microscope which shows the micro-structure of the 316 L/FeNiCoMo interface (FIG. 4A) and the FeNiCoMo/18MND5 interface (FIG. 4B) in the case of a 316 L/FeNiCoMo/18MND5 assembly obtained in example 4 by diffusion welding using Hot Isostatic Pressing for 4 hours at 1100° C. and at 1200 bar.

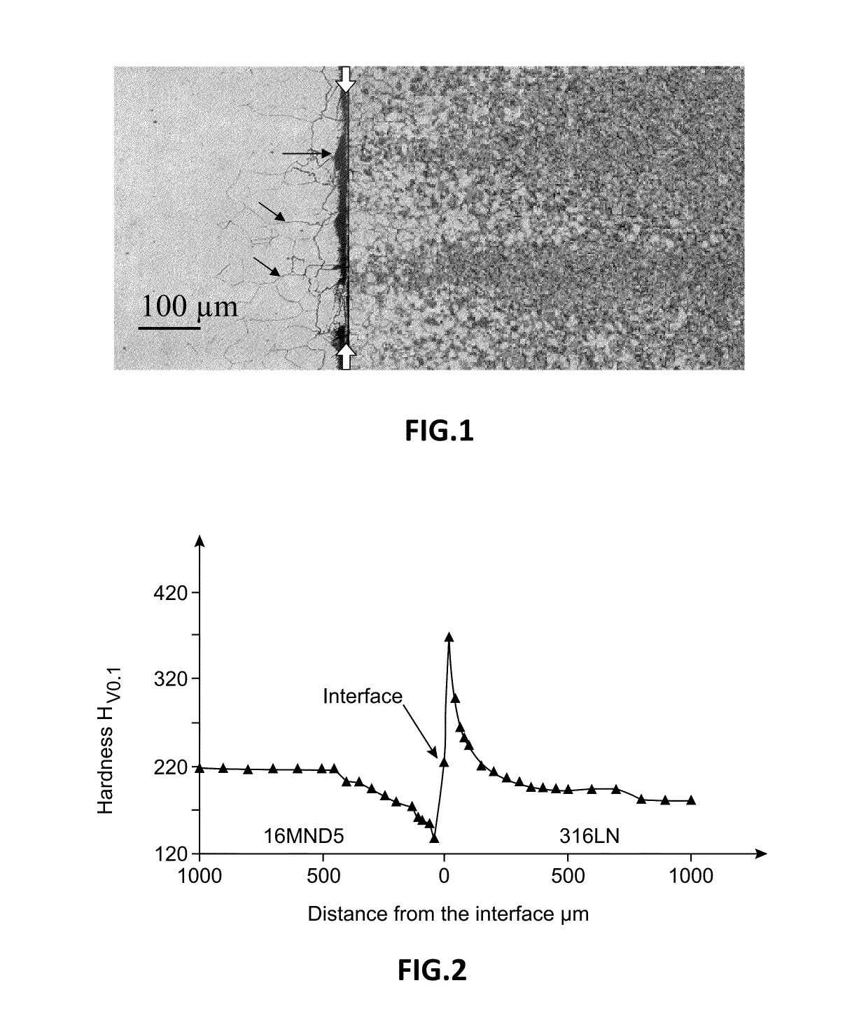

The scale shown in FIGS. 4A and 4B represents 50 μm.

### DETAILED DESCRIPTION OF SPECIFIC EMBODIMENTS

The process of the invention therefore involves joining by diffusion welding a part made of steel having a high carbon content and low carbide-forming elements content with a part made of steel or nickel alloy having a low carbon content and a high carbide-forming elements content.

Obviously, for convenience, the case of an assembly of two parts is described, but the number of parts to be assembled may be greater than 2, and a larger number of parts may therefore be simultaneously assembled.

“Part” is generally understood to mean any element or entity of any shape whatsoever, which is included for example, after assembly, simultaneously or not, with one or more other pieces, in structures of larger dimensions.

No limitation exists as to the geometry, the shape and the size of the parts assembled by the process according to the invention. In particular, the process according to the invention may be used with parts which have complex and complicated geometries and shapes, in particular which possess surfaces to be assembled, interfaces with complex complicated shapes.

The steel having a high carbon content and low carbide-forming elements content and the steel or nickel alloy having a low carbon content and a high carbide-forming elements content, as well as the intermediate material, have already been defined in detail above.

The process according to the invention generally comprises the usual steps used in a diffusion welding process.

Thus the process according to the invention may comprise the following steps:
cleaning of the surfaces of the parts to be assembled and optionally of the intermediate material;
the setting up in place of the parts to be assembled and of the intermediate material (it could be said that the parts and the intermediate material are stacked together), for example in a container.
The parts and the intermediate material are simultaneously subjected to a heating and compression cycle in order to carry out the diffusion welding;

This heating and compression cycle may be carried out by hot isostatic pressing (compaction) using a hot isostatic press or by hot uniaxial compression using a hot uniaxial compression pressing system equipped with a furnace;
the assembly obtained is cooled;
the assembly is unloaded, for example the optional container is opened;
optionally the assembly obtained is subjected to one or more heat treatment operations intended in particular to restore the initial properties of the materials.

Thus the process according to the invention preferably comprises first of all cleaning the two surfaces of the parts to be assembled. Cleaning in particular removes impurities which are likely to hinder diffusion.

It is implemented according to techniques known to those skilled in the art and relates to all the parts to be assembled, including the intermediate material when it is in the form of a sheet, panels or coating. When it is in powder form, cleanliness is ensured by suitable storage conditions.

Cleaning may be carried out, for example, through the techniques described in document FR-A1-2 758 752 or in document FR-A1-2 779 983, to whose descriptions reference may be made and by optionally adapting these techniques to the particular characteristics of the parts to be assembled and of the intermediate material which are to be used in the process according to the invention.

The next step is placing or positioning of the parts to be assembled and of the intermediate material, for example in a container, also known as a sleeve or an envelope.

It could be said that the parts and the intermediate material are positioned or put in place according to a desired stacking, with the intermediate material being arranged between the surfaces to be assembled of the parts to be assembled.

When the intermediate material is in the form of a coating, the coating is made on the surface of any of the parts to be assembled or on the surfaces of the two parts to be assembled and the zone upon which the coating is made respectively comprises at least the surface to be assembled of one of the parts to be assembled or the surfaces to be assembled of the two parts to be assembled.

By making the intermediate material filler in the form of a coating on at least one of the surfaces to be assembled of the parts to be assembled, preferably by a thermal spraying technique, it is possible to assemble parts with interfaces of complex and complicated shape and geometries, whereas it is difficult and costly to shape a sheet or panel into a complicated geometry.

In the case where the intermediate material is in the form of a powder, this may be arranged in a layer on the surface of one of the parts to be assembled then the second part to be assembled arranged on the powder. Alternatively, a housing is made between the parts to the assembled then this housing filled with powder through an orifice.

In the case where one of the parts to be assembled is in the form of powder, whilst the other is in sold form (one solid part), the placement of the parts to be assembled and of the intermediate material consists of making a stack by separating the part in the form of powder from the part in solid form using the intermediate material. For example, the part in powder form may be arranged in a container, covered with the intermediate material then the part in solid (one piece), massive form placed on top.

In the case where the two pieces to be assembled are in powder form, the intermediate part is generally in the form of a sheet or of a panel and separates the two parts in powder form arranged in a container.

The parts and the intermediate material put in place or stacked then simultaneously undergo a heating and compression cycle in order to carry out the diffusion welding, optionally accompanied by compaction of the powder, as explained above.

According to the invention, diffusion welding is by definition achieved through treatment at a sufficiently high pressure and temperature for a sufficiently long period to form an assembly and a strong bond.

This temperature is generally from 800° C. to 1200° C., preferably from 950° C. to 1150° C., for example 1100° C., and this pressure is generally from 5 to 200 MPa, preferably from 50 to 150MPa, for example 100MPa.

The period for which this temperature and this pressure is to be maintained is generally from 0.5 to 10 hours, preferably from 1 to 5 hours, for example about 4 hours.

The heating and compression cycles may be made up of several phases carried out at different temperatures and pressures, for different times.

Diffusion welding may be carried out for example by hot uniaxial pressing (hot uniaxial compression) or by hot isostatic pressing (HIP), with this last technique being preferred.

In effect hot isostatic pressing allows in particular parts of complex shape and of large size to be assembled, for example with masses of up to several tonnes. According to the invention, when diffusion welding is carried out by hot isostatic compression, the parts and the intermediate material put in place may be introduced into an envelope, sleeve or container, allowing the parts to be assembled to be isolated from the atmosphere and the envelope placed under vacuum for the assembly of parts by diffusion welding within it.

Obviously the step of setting the parts and of the intermediate material in place may also be carried out directly inside the envelope.

This envelope is made in a conventional manner known to the man skilled in the art, generally using boiler making techniques.

Once the envelope has been filled it is degassed and sealed off using techniques known to the man skilled in the art.

The parts and the intermediate material placed in the degassed envelope can then be assembled by diffusion welding.

The heating and compression cycle generally comprises, successively:
an increase in temperature and in pressure, generally from ambient temperature and pressure, up to the temperature and pressure defined above, at which diffusion welding is carried out;
a plateau at said pressure and at said temperature at which diffusion welding is carried out over the period defined above;
a decrease in the temperature and pressure generally to ambient temperature and pressure.

As an example, the following HIP cycle can be carried out:
Rise to 1050° C. and 1200 bar (120 MPa) in 3 hours,
Hold at 1050° C. and 1200 bar (120 MPa) for 2 hours,
Decrease to 20° C. and 30 bar (3 MPa) in 4 hours.

Finally, following the diffusion welding step using HIP, the product obtained, that is the assembly of the part made of steel having a high carbon content and a low carbide-forming elements content with a part made of steel or nickel alloy having a low carbon content and high carbide-forming elements content, which includes a joint made of the intermediate material, is usually subjected to an operation for de-sleeving or for opening of the envelope, for example by machining.

According to the invention, the assembly may also be made by hot uniaxial pressing (hot uniaxial compression).

The parts to be assembled and the intermediate material may be arranged in a press equipped with a heating system and with a vacuum chamber, enclosure.

A vacuum of the order of about 10⁻¹ to 10⁻³ Pa can then be created in said enclosure.

Hot uniaxial pressing may be carried out by applying a pressure of about 1 to 100 MPa, for example of from about 5 to 30 MPa.

The heating cycle generally comprises, successively:
an increase in temperature, generally from ambient temperature, up to the temperature at which diffusion welding is carried out;
a plateau at said temperature for a period which is sufficient for carrying out diffusion welding;
a decrease in the temperature generally to ambient temperature.

The temperatures and times for this cycle may be for example identical to those described for the hot isostatic compression.

The assembly obtained is then withdrawn, unloaded from the press.

According to the invention, the assembly obtained may be subjected in addition to one or more heat treatment(s).

The optional heat treatment step may be carried out before or after de-sleeving. The purpose of these heat treatment operations is generally to restore the properties and the micro-structure of the materials of the assembled parts. Thus the assembly may undergo one or more heat treatment operations, generally chosen from the heat treatment operations recommended for the constituent materials of the assembly.

Thus a compromise might have to be defined between an austenitisation, hardening and tempering heat treatment operation for the high carbon-content steel and a hyper-tempering treatment operation for the steel or nickel alloy having a low carbon content.

The assembly according to the invention is of sufficient strength for the hardening and tempering treatment operations not to damage the assembly that is formed.

The assemblies of parts prepared by the process according to the invention find application in particular in the replacement of “stainless steel smearing, buttering” of components of Pressurised Water Reactors (PWR).

Other applications of the assemblies according to the invention are anti-corrosion applications where a structural material of carbon-steel type and a surface material of the stainless steel type are associated.

The invention will now be described with reference to the following examples, given as illustrations and non-restrictively.

### EXAMPLES

### Example 1

### Comparative

Hot Isostatic Compression for 1 hour at 1050° C. and at a pressure of 1000 bar is used for the diffusion welding of two disks with a diameter of 100 mm and a thickness of 50 mm, made respectively of 16MND5 steel (Fe-0.165% C-1.30% Mn-0.74% Ni-0.18% Cr-0.48% Mo) and of a IN690 nickel alloy (Ni-0.021% C-10.1% Fe-29.2% Cr-0.2% Ti-0.13% Al).

After diffusion welding the assembly is heated to 900° C. for 30 min, oil-hardened and then tempered for 5 h at 640° C. in order to restore the micro-structure and properties of the 16MND5 steel.

Tensile and impact strength test pieces as well as metallographic samples intended for metallurgical analyses are taken from the assembly.

The interface is observed by optical microscopy.

The tensile test pieces are cylindrical and have a shaft of diameter 4 mm and a useful length of 25 mm.

Impact strength test-pieces are bars with a square cross-section 10 mm×10 mm and with a length of 55 mm.

Impact resistance tests are carried out in accordance with standard EN ISO 148-1 of October 2010, with a U-shaped notch positioned at the interface.

The results of the impact resistance and tensile tests are given in Table 1 below.

As envisaged there is carburisation of the nickel alloy.

The failure under tension at 20° C. and at 300° C. takes place either in the first case in the joint zone (in a mixed manner at the interface and in the carburised zone of the nickel alloy), or in the second and better of the cases, in the nickel alloy, away from the interface. In the first case, the breaking stress is less than the mechanical strength of the weaker material, the nickel alloy.

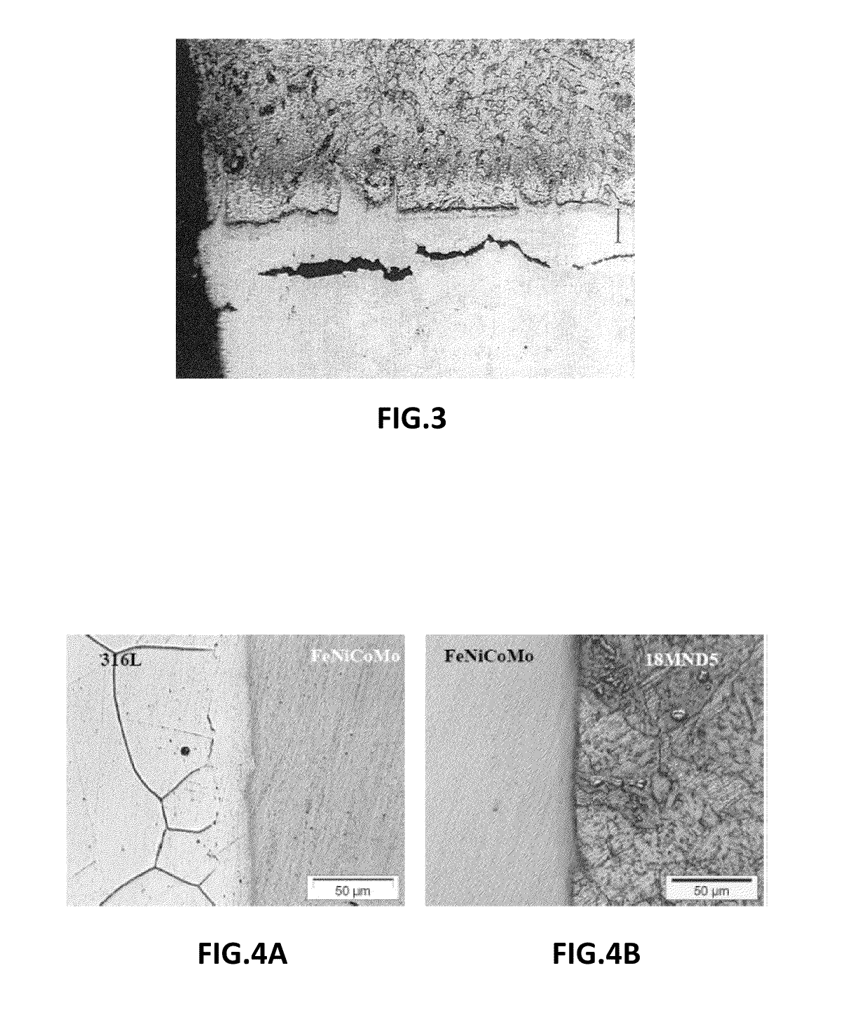

In the second case microscopic observation after testing shows that the nickel alloy is damaged at the carburised zone although the break finally occurred away from this zone (FIG. 3).

The impact strength values obtained are very low, of the order of a few Joules, more precisely from 2 to 6 J. This assembly is therefore fragile.

### Example 2

### Comparative

Example 1 is repeated with the same parts using the same materials, the same conditions for diffusion welding and the same treatment after diffusion welding, the only difference being that before diffusion welding a nickel strip with a thickness of 30 μm is arranged between the two disks made of steel and made of nickel alloy.

After diffusion welding the metallurgical analysis shows that the nickel has actually acted as a barrier to the diffusion of carbon.

It is observed, however, that the assembly splits spontaneously during hardening, demonstrating its brittleness. The use of nickel as the intermediate material is therefore not a good solution.

### Example 3

### Comparative

Hot Isostatic Pressing for 1 hour at 1100° C. and at a pressure of 1000 bar is used for the diffusion welding of two disks with a diameter of 100 mm and a thickness of 50 mm, made respectively of 16MND5 steel (Fe-0.165% C-1.30% Mn-0.74% Ni-0.18% Cr-0.48% Mo) and of a 316 LN austenitic stainless steel (Fe-0.022% C-17.5% Cr-12.16% Ni-1.73% Mn-2.40% Mo).

Before the diffusion welding, a sheet of iron-nickel (Fe-42% Ni) intermediate material of thickness 1 mm is placed between the two materials.

After diffusion welding the assembly is heated to 900° C. for 30 min, oil-hardened and then tempered for 5 h at 640° C. in order to restore the micro-structure and properties of the 18MND5 steel.

Tensile and impact strength test pieces as well as metallographic samples are taken from the assembly.

The interfaces are observed using optical microscopy.

The tensile test pieces are cylindrical and have a shaft of diameter 4 mm and a useful length of 25 mm.

Impact strength test-pieces are bars with a square cross-section 10 mm×10 mm and with a length of 55 mm.

Impact resistance tests are carried out in accordance with standard EN ISO 148-1 of October 2010, with a U-shaped notch positioned at the mid-thickness point of the intermediate material.

The results of the impact resistance and tensile tests are given in Table 1 below.

As in example 2, the metallurgical analysis shows that that the iron-nickel strip has actually acted as a barrier to the diffusion of the carbon.

The failure under tension takes place either in the intermediate material or at the iron-nickel/316 LN interface.

In the impact strength testing, the impact energy is 40+/−3J, a value which is significantly less than that of the base materials of the assembly.

Failure essentially occurs in the intermediate material which therefore constitutes the weak point in the assembly.

### Example 4

### According to the Invention

Hot Isostatic Compression for 4 hours at 1100° C. and at a pressure of 1200 bar is used for the diffusion welding of two disks with a diameter of 100 mm and a thickness of 50 mm, made respectively of 18MND5 steel (Fe-0.18% C-1.51% Mn-0.22% Si-0.66% Ni-0.19% Cr-0.52% Mo) and a 316 L steel (Fe-0.013% C-1.83% Mn-0.23% Si-10.24% Ni-16.89% Cr-2.04% Mo).

Arranged between these two disks, according to the invention, is a strip of thickness 1 mm and made of an intermediate material according to the invention, which is a FeNiCoMo alloy (Fe-45.3% Ni-9.97% Co-5.19% Mo.

After diffusion welding, the assembly is heated to 900° C., quenched in a stream of air and then tempered for 5 h at 650° C.

Tensile and impact strength (resilience) test pieces as well as metallographic samples are taken from the assembly.

The interfaces are observed using optical microscopy.

The tensile test pieces are cylindrical and have a shaft of diameter 4 mm and a useful length of 25 mm.

The impact strength (resilience) test-pieces are bars with a square cross-section 10 mm×10 mm and with a length of 55 mm.

Impact strength (resilience) tests are carried out in accordance with standard EN ISO 148-1 of October 2010, with a V-shaped notch (more severe than a U-shaped notch) positioned at the mid-thickness point of the intermediate material.

The results of the impact strength and tensile tests are given in Table 1 below.

FIG. 4 shows that there is no carburisation of the 316 L steel (4A) or carburisation of the 18MND5 (4B). Despite the carbide-forming character of the molybdenum, there is no carburisation of the FeNiCoMo material.

During tensile tests at ambient temperature, no failure, rupture, is observed either at the interface or in the intermediate material, but in the 316 L.

The impact strength obtained when the notch is positioned at the mid-thickness point of the FeNiCoMo intermediate material according to the invention, that is 168J, remains lower than that obtained for each of the two constituent materials of the assembly, but is greatly improved in comparison with examples 1 and 3. Furthermore failure, rupture, occurs in part in the 316 L stainless steel whereas the test configuration favours failure, rupture, at an interface or in the FeNiCoMo intermediate material.

TABLE 1
Mechanical properties of assemblies made in the examples.

| Test | Tensile | Impact strength | |
|---|---|---|---|
| Assembly | Location of | Rupture | Location |
| | rupture | energy | of rupture |
| Example 1 | IN690 away from | 2-6J | interface |
| 16MND5/IN690 | the interface or | (KCU) | |
| | carburised IN690 | | |
| Example 2 | Spontaneous failure of the assembly | | |
| 16MND5/Ni/IN690 | during heat treatment | | |
| Example 3 | In Fe-42Ni | 63+/−4J | Fe-42Ni and |
| 16MND5/Fe-42Ni/316LN | | (KCU) | Fe- |
| | | | 42Ni/316LN |
| | | | interface |
| Example 4 | In the 316L | 169J | FeNiCoMo |
| 18MND5/FeNiCoMo/316L | | (KCV) | and 316L |

The results of the mechanical testing shown in Table 1 clearly indicate that the use of an intermediate material made of FeNiCoMo not only eliminates the embrittlement of the materials by the diffusion of carbon, but also results in an assembly being obtained of greater strength than with intermediate materials representative of the prior art.

The comparison of the examples shows that the improvement provided by the invention is essentially due to the addition of Mo to the intermediate material.

This addition strengthens the intermediate material without adversely affecting the interfaces (FIGS. 4A and 4B) or the materials to be assembled.

### REFERENCES

[1] L. Bedel, V. Rougier, L. Briottet, G. Delette, M. Ignat, “Interfacial diffusion and local mechanical properties in a bimetallic specimen”, Phys. Mesomech., 7, No. 3-4 (2004) p 81.
[2] T. Enjo, K. Ikeuchi, S. Yoshizaki, “Diffusion bonding of carbon steel S45C to Austenitic stainless steel SUS304”, Journal of high temperature society of Japan, 14(2) pp 55-65, 1988.
[3] B. Kurt “The interface morphology of diffusion bonded dissimilar stainless steel and medium carbon steel couples”, Journal of Materials Processing Technology 190 (2007) pp 138-141.
[4] J. Besson, Y. Madi, A. Motarjemi, M. Koçak, G. Martin, P. Hornet “Crack initiation and propagation close to the interface in a ferrite-austenite joint”, Materials science and engineering A397 (2005) pp 84-91
[5] R. Prader, B. Buchmayr, H. Cerjak, J. Peterselm, A. Fleming, “Microstructures and mechanical properties of graded composition joints between different heat resistant steels”, Conférence PGM 94, Presses Polytechniques et Universitaires Romandes, pp 479-485 (1995).
[6] J. W. Dini, “Use of electrodeposition to provide coatings for solid state bonding”, Welding Journal, November 1982, pp 33-39.
[7] H. P. Buchkremer, P. J. Ennis, D. Stöver, “Manufacture and stress rupture properties of hipped austenitic-ferritic transition joints”, Journal of Materials Processing Technology 92-93 (1999) pp 368-370.
[8] R. J. Klassen, G. C. Weatherly, B. Ramaswami “Fracture mechanisms in constrained Ni interlayers”, Materials science and engineering A161 (1993) pp 181-186.
[9] H. V. Atkinson, N. W. Crabbe, R. Walker, “HIP diffusion bonding of austenitic to ferritic steels”, Conference Diffusion Bonding 2, Cranfield, UK, March 1990 pub. Elsevier.

1-14. (canceled)

15. A process for joining by diffusion welding a part made of steel having a high carbon content and a low carbide-forming elements content with a part made of steel or of nickel alloy having a low carbon content and a high carbide-forming elements content, each of the parts comprising a surface to be joined, in which process an intermediate material is placed between the surfaces to be joined, then diffusion welding is carried out to join the two parts, and the assembly obtained is cooled, wherein the intermediate material is an alloy with a matrix made of nickel and optionally of iron and/or cobalt, having an austenitic micro-structure at the diffusion welding temperature, and comprising, apart from unavoidable impurities, the following elements with the following contents, expressed as % by mass relative to the total mass of the alloy:
Nickel (Ni): 5 to 90;
Cobalt (Co): 0 to 50;
Iron (Fe): 0 to 93;
Molybdenum: 2 to 25;
Carbon: less than 0.10;
Chromium: less than 10;
Alloy elements commonly used in austenitic alloys, for each of them: less than 2.

16. A process according to claim 15 wherein the alloy of the intermediate material comprises one or more among the following alloy elements commonly used in austenitic alloys with the following contents, expressed as % by mass relative to the total mass of the alloy:
Manganese (Mn): less than 2;
Silicon (Si): less than 1;
Calcium (Ca): less than 0.5;
Aluminium (Al): less than 1.

17. A process according to claim 15, wherein the alloy of the intermediate material consists of, as % by mass relative to the total mass of the alloy, of:
Nickel: 35 to 55;
Cobalt: 0 to 18;
Molybdenum: 4 to 8;
and the remainder being iron and unavoidable impurities.

18. A process according to claim 15, wherein the intermediate material is placed between the surfaces to be assembled in the form of a sheet or of a plate, with a thickness of 0.1 to 3 mm, or in the form of a powder, optionally a layer of powder, with a thickness of from 0.3 to 10 mm.

19. A process according to claim 15, wherein the intermediate material is deposited in the form of a coating with a thickness of 0.1 to 3 mm, on at least one of the surfaces to be assembled.

20. A process according to claim 19, wherein the intermediate material is deposited by a process chosen from the group consisting of thermal spray-coating of powders, wire melting, chemical or electrolytic deposition and vacuum deposition.

21. A process according to claim 15, wherein the steel having a high carbon content and a low carbide-forming elements content comprises more than 0.08% by mass of carbon and less than 15% by mass of carbide-forming elements, and the steel or nickel alloy having a low carbon content and high carbide-forming elements content comprises 0.08% by mass or less of carbon and 15% by mass or more of carbide-forming elements.

22. A process according to claim 15, wherein the carbide-forming elements are chosen from elements in columns IVB, VB and VIB of the periodic table of the elements.

23. A process according to claim 15 wherein the steel having a high carbon content and low carbide-forming elements content is chosen from the group consisting of carbon steels grades and low alloy steels grades; and the steel or nickel alloy having a low carbon content and a high carbide-forming elements content is chosen from the group consisting of stainless steels and nickel alloys.

24. A process according to claim 15, wherein at least one of the two parts to be assembled is in the form of a powder.

25. A process according to claim 15, wherein the diffusion welding is carried out by Hot Isostatic Pressing (HIP).

26. A process according to claim 15, wherein the diffusion welding is carried out by uniaxial compression.

27. A process according to claim 15, wherein the assembly obtained is further subjected to one or more heat treatment(s).

28. A process according to claim 15, wherein the intermediate material comprises the following elements with the following contents, expressed as % by mass relative to the total mass of the alloy:
Nickel (Ni): 35 to 75;
Cobalt (Co): 0 to 20;
Iron (Fe): 23 to 63;
Molybdenum: 4 to 16;
Carbon: less than 0.05;
Chromium: less than 5;
Alloy elements commonly used in austenitic alloys, for each of them: less than 1.

29. A process according to claim 16, wherein, the alloy of the intermediate material comprises one or more among the following alloy elements with the following contents, expressed as % by mass relative to the total mass of the alloy:
Calcium (Ca): less than 0.1;
Aluminium (Al): less than 0.5.

30. A process according to claim 17, wherein the alloy of the intermediate material consists of, as % by mass relative to the total mass of the alloy, of:
Nickel: 45.3;
Cobalt: 9.97;
Molybdenum: 5.19.

31. A process according to claim 18, wherein the intermediate material is in the form of a layer of powder with a thickness from 1 mm to 5 mm.

32. A process according to claim 23, wherein the steel having a high carbon content and low carbide-forming elements content is chosen from the group consisting of engineering steels, steels for pressure equipment and tool steels; and the steel or nickel alloy having a low carbon content and a high carbide-forming elements content is chosen from the group consisting of 300-series austenitic stainless steels and alloy 800.

33. An assembly obtained by the process according to claim 15, said assembly comprising a part made of steel having a high carbon content and a low carbide-forming elements content, and a part made of steel or of nickel alloy having a low carbon content and a high carbide-forming elements content, welded together by diffusion welding.
